(19) United States
(12) Patent Application Publication
(10) Pub. No.: US 2014/0255614 A1
(43) Pub. Date: Sep. 11, 2014

(54) System and Method of Producing a Coating with an Electrostatic Spray

(71) Applicant: Finishing Brands Holdings Inc., Minneapolis, MN (US)

(72) Inventors: Steven Andrew Myers, Scottsdale, AZ (US); Payton Xavier Cozart, Toledo, OH (US)

(73) Assignee: Finishing Brands Holdings Inc., Minneapolis, MN (US)

(21) Appl. No.: 14/205,181

(22) Filed: Mar. 11, 2014

Related U.S. Application Data
(60) Provisional application No. 61/776,632, filed on Mar. 11, 2013.

(51) Int. Cl. B05D 1/00; B05B 5/16

(52) U.S. Cl. CPC B05D 1/007; B05B 5/16
USPC 427/483; 118/722; 118/715; 239/690

(57) ABSTRACT

A system including an electrostatic spray system, including an electrostatic tool configured to charge and spray a PTFE, a material delivery system configured to deliver the PTFE to the electrostatic tool, a gas delivery system configured to deliver an airflow that atomizes the PTFE and sprays the charged PTFE on a target, and an infrared curing system configured to cure the PTFE on the target to produce a coating.

### BACKGROUND

The invention relates generally to a system and method of producing a coating with an electrostatic spray.

Electrostatic tools spray electrically charged materials to more efficiently coat objects. For example, electrostatic tools may be used to paint objects. In operation, a grounded target attracts electrically charged materials sprayed from an electrostatic tool. As the electrically charged material contacts the grounded target, the material loses the electrical charge.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including an electrostatic spray system, including an electrostatic tool configured to charge and spray a PTFE, a material delivery system configured to deliver the PTFE to the electrostatic tool, a gas delivery system configured to deliver an airflow that atomizes the PTFE and sprays the charged PTFE on a target, and an infrared curing system configured to cure the PTFE on the target to produce a coating.

In another embodiment, a system including an electrostatic spray system, including an electrostatic tool having a round tip spray assembly, configured to spray polytetrafluoroethylene with an electrostatic charge, and a controller configured to adjust parameters of the electrostatic spray system to output a polytetrafluoroethylene spray with particles with a mean diameter between approximately 32-42 microns.

In another embodiment, a method for producing a part with an electrostatic spray system, including preparing a coating material, preparing a target for receipt of the coating material, electrostatically spraying coating material as a spray onto the target to create a coating material layer, adjusting parameters of the electrostatic spray system to produce approximately 32-42 micron mean diameter particle size with the coating material in the spray, and curing the coating material layer.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of an electrostatic spray system;

FIG. 2 is an exploded perspective view of an embodiment of a round spray tip assembly;

FIG. 3 is a perspective view of an embodiment of an assembled round spray tip assembly;

FIG. 4 is a flowchart of an exemplary method for using the electrostatic spray system of FIG. 1.

FIG. 5 is a flowchart of an exemplary method for adjusting the parameters in a method for electrostatically spraying a coating material; and

FIG. 6 is a cross-sectional view of an embodiment of a target coated with a coating material.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed towards an electrostatic system and associated methods for using, operating, and manufacturing. Specifically, the electrostatic system may fabricate products and coat objects using a friction reducing material (e.g., polytetrafluoroethylene). Polytetrafluoroethylene may be shear sensitive, and therefore sensitive to spraying parameters. The methods/processes described below enable an electrostatic system to coat objects within proper tolerances and with the proper characteristics, using shear sensitive friction reducing coating materials. For example, some of the embodiments described below may use specific types of spraying equipment in combination with specific spraying parameters, in order to spray shear sensitive coating materials. The disclosed embodiments also describe methods that adjust various spraying parameters that enable production of products within particular tolerances. These parameters may include coating material flow rates, airflow rates, atomization pressure, voltage applied to coating material, conveyer speeds, the numbers of coats, and distance to a target.

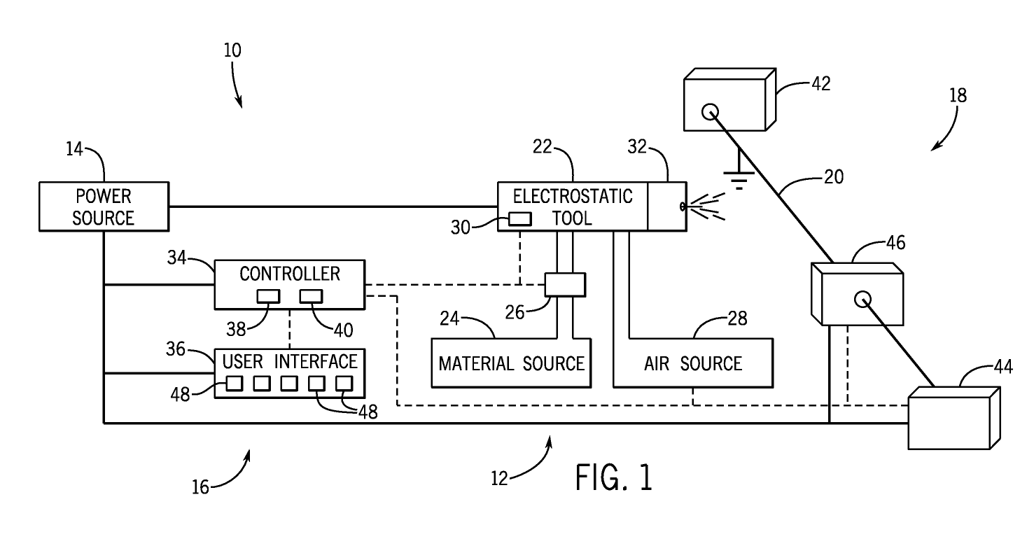

FIG. 1 is a schematic of an electrostatic spray system 10 capable of spraying a friction reducing material to coat products (implantable medical devices, syringe needles, stents, guide wires, catheters, etc.). The friction reducing material may be acid or water based polytetrafluoroethylene (i.e., polytetrafluoroethylene that is suspended in acid or water); silicone lubricant, molybdenum disulphide, boron nitride, etc. Unfortunately, liquid polytetrafluoroethylene (PTFE) may be shear sensitive that is PTFE may be easily pulled out of suspension from an acid or water suspender. The separation of the acid and water from the PTFE may change the viscosity and adhesive properties of the coating material, thus blocking proper application onto a target surface. The electrostatic spray system 10 combines hardware with spraying parameters to coat a target surface with shear sensitive PTFE.

The electrostatic spray system 10 includes a material delivery system 12; a power source 14; controller system 16; and a target movement and curing system 18. These systems operate together to spray an electrically charged friction reducing coating material (e.g., PTFE) onto a target 20. The material delivery system 12 includes an electrostatic tool 22 (e.g., spray device), a material source 24 (e.g., tank), a material delivery component 26, and an air source 28 (e.g., air tank and/or compressor). In operation, the electrostatic spray system 10 uses the power source 14 to power the material delivery system 12. The electrostatic tool 22 receives power from the power source 14, material (e.g., liquid) from the material source 24, and airflow from the air source 28. The electrostatic tool 22 combines the power, the coating material, and the airflow to spray the friction reducing coating material. Specifically, the electrostatic tool 22 electrically charges, atomizes, and sprays the friction reducing coating material (e.g., liquid) onto the target 20. As explained above, the friction reducing coating material may be shear sensitive. Accordingly, the material delivery system 12 may include the material delivery component 26 to facilitate movement of the friction reducing coating material into the electrostatic tool 22. The material delivery component 26 may be a pressure pot or a syringe pump capable of delivering the friction reducing coating material to the electrostatic tool 22 without excessive shearing.

In the illustrated example, the electrostatic tool 22 may be a gas spray gun (e.g., a spray gun that sprays air or another type of gas) with a round spray tip assembly 32 and a voltage multiplier 30. The round spray tip assembly 32 enables atomization and spraying of the friction reducing coating material in a round spray pattern using airflow from the air source 28. More specifically, the round spray tip assembly 32 facilitates atomization at low velocities (e.g., a round spray tip may not include pattern airflow or fan airflow that increases particle velocity). The low velocity of the coating material may also assist in coating the target by increasing the ability of the electrostatics to attract the coating material, instead of pushing the coating material past the target. The round spray tip assembly may produce mean diameter particle sizes between 25-50 microns (e.g., approximately between 30-45 microns, 32-42 microns, or 34-37 microns). Depending on the surface tension of the liquid and atomization method used, particles can range from 5-200 microns in size. The size of the material particles affects how the material eventually coats on the target 20. For example, a particle size that is too small may dry before reaching the target, while an excessively large particle size may pool, run on the target, and produce a coating outside proper tolerances. Furthermore, a particle size that is too large may block the electrostatic tool from effectively charging the particle for attraction to the target 20 (i.e., large particles may receive insufficient charge to wrap around a target).

In order to electrically charge the coating material, the electrostatic tool 22 includes the voltage multiplier 30. The voltage multiplier 30 receives the power from the power source 14. The power source 14 may be an external power source (e.g., power grid, electrical generator etc.), an internal power source (e.g., a battery or electrical generator), or a combination of an external power source and an internal power source. The voltage multiplier 30 receives power from the power source 14 and converts the power to a higher voltage to be applied to the coating material in the electrostatic tool 22. More specifically, the voltage multiplier 30 may apply power to the material with a voltage between approximately 50 kV and 100 kV or greater. For example, the power may be at least approximately 55, 65, 75, 85, 95, or 100 kV. By further example, the power may be between 75-85 kV. As will be appreciated, the voltage multiplier 30 may be removable and may include diodes and capacitors. In certain embodiments, the voltage multiplier 30 may also include a switching circuit that changes the power between a positive and a negative voltage. As the coating material atomizes and charges, the coating material is sprayed onto a target 20 (e.g., guide wires, catheters, etc.). The target 20 may be grounded or oppositely charged to electrically attract the friction reducing coating material. As the material collects on the target 20, it forms a friction reducing coating.

As shown in FIG. 1, the electrostatic spray system 10 includes the controller system 16. The controller system 16 includes a controller 34 and user interface 36, which may be powered by the power source 14. As illustrated, the controller 34 includes a processor 38 and a memory 40. The memory 40 may store instructions (i.e., software code) executable by the processor 38 to control operation of the electrostatic spray system 10. The controller 34 may couple to the material delivery system 12; and the target curing and movement system 18 to control various parameters. For example, the controller 34 may control the flow of material from the material source 24, airflow from the airflow source 28, and the amount of electrical charge added to the material exiting the electrostatic tool 22 with the voltage multiplier 30.

In addition to controlling the material delivery system 12, the controller 34 may control the target curing and movement system 18. The target curing and movement system 18 may include a target source 42, a conveyer 44 (e.g., a belt, cable, etc.), and a curing station 46. In operation, the conveyer 44 may include a motor that pulls the target 20 (e.g., stents, guide wires, catheters, etc.) out of a target source 42 and past the electrostatic tool 22. In some embodiments, the target curing and movement system 18 may include the curing station 46. The curing station 46 may be an infrared curing station (e.g., one or more infrared lamps or heating elements) capable of producing high temperatures that cure the coating material on the target 20. In other embodiments, the curing station 46 may be an ultraviolet light curing station or another kind of curing station. In still other embodiments, there may not be a curing station 46; instead, the coating material may cure at room temperature conditions. To ensure the coating material adequately coats and cures on the target 20, the controller 34 controls the target conveyer 44 and the curing station 44. Specifically, the controller 34 controls the speed at which a motor in the conveyer pulls the target 20 past the electrostatic tool 22. In certain embodiments, the controller 34 may cause the conveyer to pull the target 20 between approximately 700-800 centimeters per minute. For example, the controller 34 cause the target conveyer to pull the target at least approximately 100 to 5000, 200 to 2500, 300 to 1000, 700-800, 725-775, 750-770, or 760-770 centimeters per minute. Accordingly, the controller 34 through control of the conveyer 44 ensures that the target 20 is not overcoated or overcured; or undercoated or undercured.

The user interface 36 connects to and receives information from the controller 34. In certain embodiments, the user interface 36 may be configured to allow a user to adjust various settings and operating parameters based on information collected by the controller 34. Specifically, the user may adjust settings or parameters with a series of buttons or knobs 48 coupled to the user interface 36. In certain embodiments, the user interface 34 may include a touch screen that enables both user input and display of information relating to the electrostatic spray system 10. For example, the user interface 36 may enable a user to adjust the voltage supplied by the voltage multiplier 30, turn the voltage on/off, and adjust the amount of material sprayed by the tool 12 using a knob, dial, button, or menu on the user interface 34. Moreover, the user interface 34 may include preprogrammed operating modes for an electrostatic spray system 10. These modes may be processes that change the electric charge added to a sprayed material over a period of time or that change the amount of material sprayed by the electrostatic system 10. An operator may activate one or more operating modes using a button, knob, dial, or menu 48 on the user interface 34. These preprogrammed operating modes may be a specific process for manufacturing a product, a specific step in a process, or may correspond to operating parameters for the electrostatic spray system 10 (e.g., voltage level, material discharge rate, conveyer speed, airflow rate, etc.). For example, the modes may include operating modes that are customized to a specific product (e.g., stent, guide wire, or catheter and/or a specific coating material (e.g., PTFE).

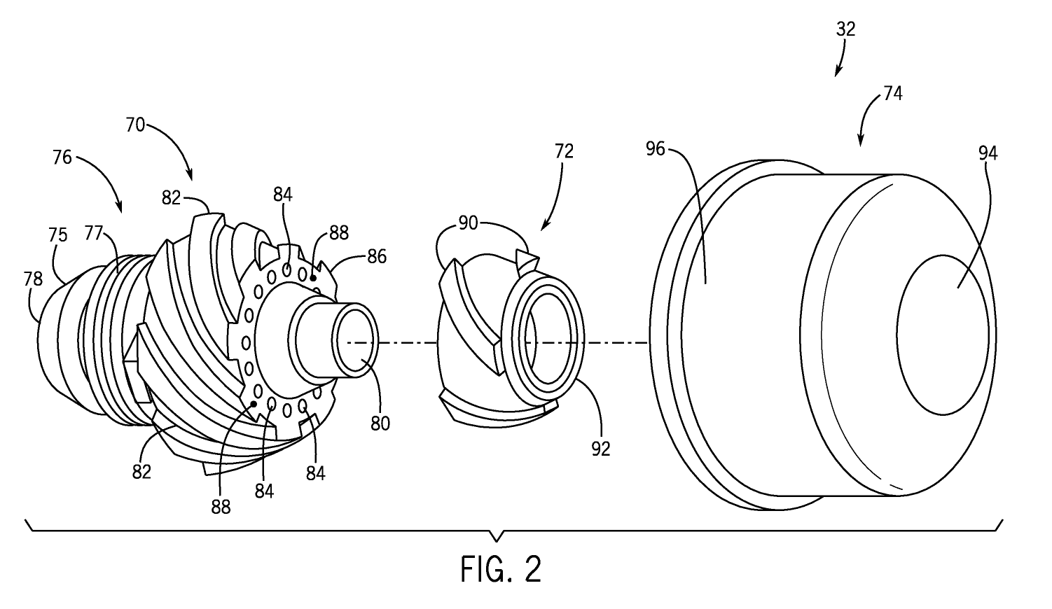

FIG. 2 is an exploded perspective view of an embodiment of a round spray tip assembly 32. The round spray tip assembly 32 includes a nozzle 70, nozzle tip 72, and an air cap 74. The nozzle 70 couples to the air spray gun 70 with a connector portion 76, which includes a compression fitting 75 (e.g., a tapered or conical wall) and a threaded portion 77 (e.g., male threads). The connector portion 76 may include an aperture 78 (e.g., internal passage) that enables an ionization needle to pass through the nozzle 70 and exit through a conduit 80. The nozzle 70 directs coating material with helical swirling vanes 82 (e.g., 1 to 100 vanes), and atomization air passages 84 (e.g., 1 to 100 passages). The helical vanes 82 enable the round spray tip assembly 32 to swirl the coating material as it exits, improving mixing and control of the coating material while spraying. As illustrated, the air atomization passages 84 are included in nozzle face 86. In addition to the air atomization passages 84, the nozzle face includes guide pins 88 (e.g., 1, 2, 3, 4, 5, or more pins). The pins 88 facilitate coupling of the nozzle cap 72 to the nozzle 70. When the nozzle 70 and nozzle cap 72 couple, helical vanes 90 (e.g., 1 to 100 vanes) enable the nozzle cap 72 to continue swirling and guiding the coating material. The nozzle cap 72 includes an aperture 92 larger than the conduit 80 to facilitate airflow through the nozzle cap from the atomization air passages. The final piece in the round spray tip assembly 32 is the air cap 74. The air cap 74 includes an aperture 94 and a cavity 96 that receive the nozzle 70 and nozzle cap 72.

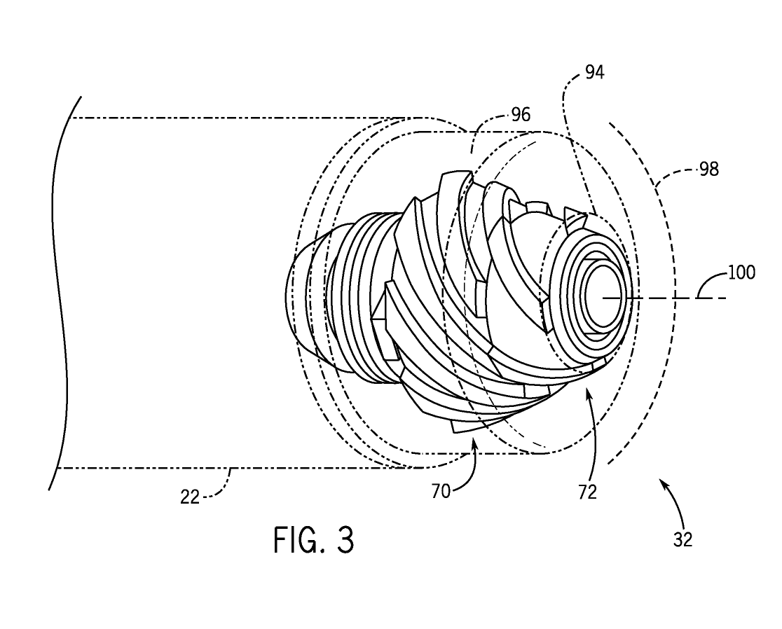

FIG. 3 is a perspective view of an embodiment of an assembled round spray tip assembly 32. As illustrated, the air cap 74 receives the nozzle 70 and the nozzle cap 72; and couples to electrostatic tool 22 (e.g., air spray gun). Once the tool 22 is assembled, the airflow from the air atomization passages 84 combines with and atomizes the coating material. The atomized coating material exits the air cap 74 through the aperture 94 where the material is electrically charged in an electrical field 98 created by the ionization needle 100.

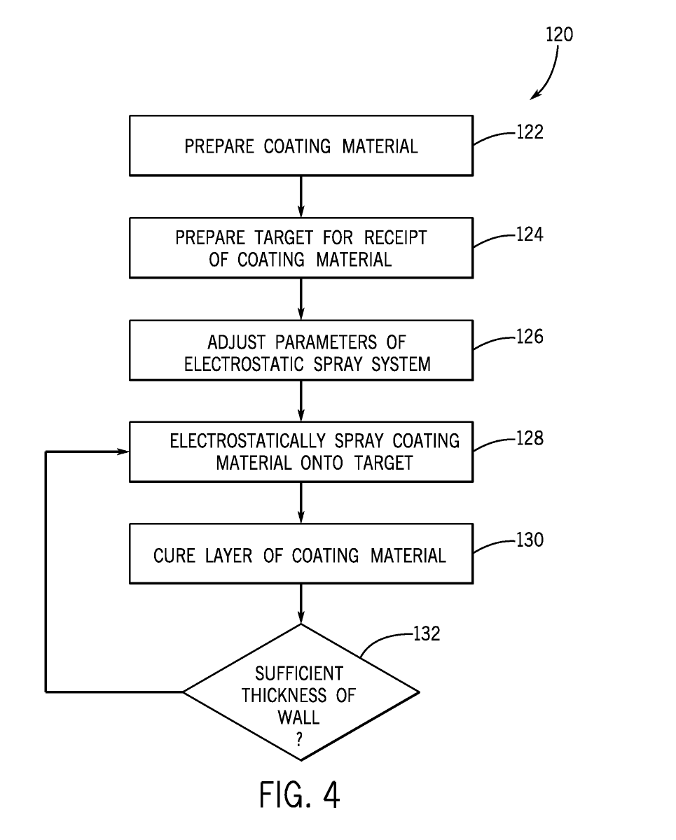

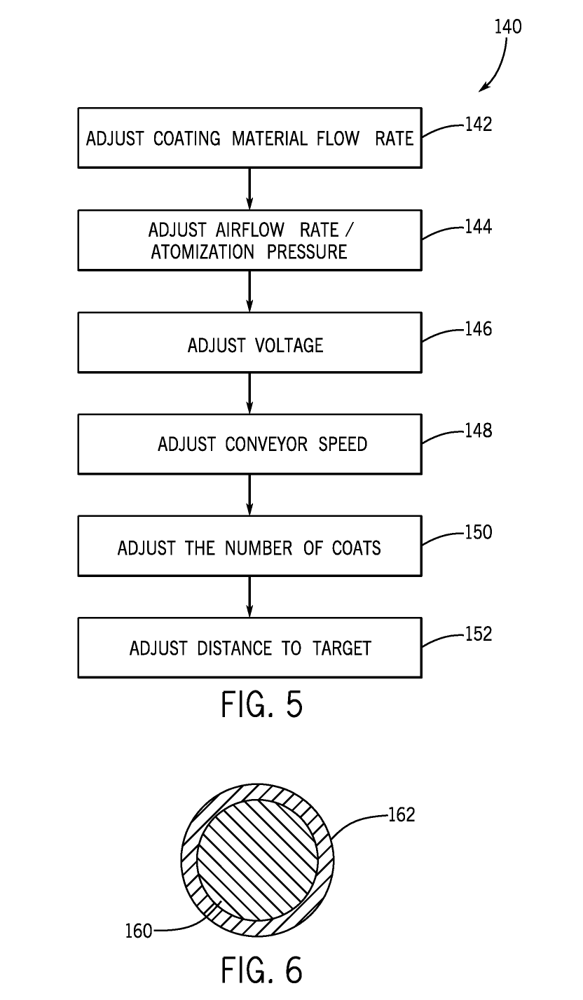

FIG. 4 is a flowchart of an exemplary method 120 for using the electrostatic spray system 10 of FIG. 1. The method 120 enables the electrostatic spray system 10 to electrostatically spray a shear sensitive PTFE coating 120 onto a target, thereby producing a PTFE coating on a target (e.g., medical product) with the proper finishes and tolerances. The method 120 begins by preparing a coating material (block 122). As discussed above, the coating material may be a shear sensitive PTFE coating material (e.g., the PTFE may easily separate from the suspender like acid or water). Preparation of the coating material may involve adding a water or acid to suspend the PTFE. The target is also prepared to receive the coating material (block 124). The target may be prepared by electrically grounding or inducing an electrical charge in the target that is opposite the charge on the coating material. In the next step, the method 120 adjusts parameters of the electrostatic spray system (block 126). The electrostatic spray system 10 may be adjusted in various ways in order to produce a part with the proper tolerances. As will be discussed in additional detail in FIG. 5, the adjustable parameters include a coating material flow rate, an airflow rate, a voltage, and a conveyer speed. After adjusting the parameters of the electrostatic spray system 10, a user may electrostatically spray the coating material onto the target (block 128). The method 120 then cures the sprayed material (e.g., open air cure, infrared cure, etc.) (block 130). After curing, the method 120 may include an additional step of determining whether the wall/coating is sufficiently thick (block 132). If the coating is insufficiently thick, the process 120 returns to block 128 and electrostatically sprays another coating material layer onto the target. The method 120 repeats this portion of the method until the coating/layer of wall meets the requisite thickness (i.e., tolerances). The thickness of the wall may be measured at the decision point or may be predetermined based on previous calculations (i.e., if the number of wall layers or coatings needed to achieve the proper thickness is known).

FIG. 5 is a flowchart of an exemplary method 140 for adjusting the parameters (block 126) in the method 120 for electrostatically producing a part as illustrated in FIG. 4. As explained above, the electrostatic system 10 includes a user interface 36. The user interface 36 enables a user to adjust operating parameters in order to produce the part within the proper specifications. Specifically, the user may adjust parameters based on the coating material, changes in tolerances, etc. For example, a medical component may need a specific PTFE coating thickness. Accordingly, a user may adjust parameters of the electrostatic spray system 10 to adjust for changes in part tolerances, cure time, etc.

The method 140 begins with a step 142 for adjusting a coating material flow rate. The controller 34 may connect to a material delivery component 26 (e.g., a pressure pot, syringe pump, etc.) that moves the coating material from the coating material source 24 and into the electrostatic tool 22. The coating material flowrate may be adjusted between approximately 5-200 cc/min, 50-150 cc/min, 75-100 cc/min, and 85-90 cc/min The material flow rate controls how much coating material is sprayed by the electrostatic tool 22. A high flow rate may cause material to run on the target while low flow rates may block a sufficient amount of material from contacting the target. In step 144, the method 140 adjusts the airflow rate/atomization pressure. The airflow rate determines the atomization pressure of the electrostatic tool 22 at the round spray tip assembly 32. The higher the air flowrate the higher the atomization pressure. The airflow rate may be adjusted between approximately 350-450 standard liters/min or 375-425 standard liters/min; to produce an atomization pressure between approximately 13-15 psi or 13.5-14.5 psi. As the airflow rate increases, the atomization pressure increasingly breaks up the coating material into finer and finer particles. The finer particles are more easily charged, but may prematurely dry out before the coating material effectively coats the target. However, if the atomization pressure and airflow rate are too low, the coating material may not sufficiently break apart and thus block effective charging of the particles and may induce the material to run on the target. Accordingly, the coating material flowrate and the airflow rate/atomization pressure may be adjusted to produce a particle size with a mean diameter between approximately 30-50 microns, 32-42 microns, 34-38 microns, or 34-36 microns. In step 146, the method 140 enables adjustment of the applied voltage that facilitates attraction to the target. The amount of voltage applied may vary in proportion to the distance between the electrostatic tool 22 and the target 20. For example for approximately every 1″ the voltage may increase by approximately 10 kV. The voltage may be between approximately 5-100 kV, 50-100 kV, 60-90 kV, or 75-85 kV. In step 148, the method 140 may adjust a conveyer speed. The conveyer speed may directly affect the amount of material applied to a target as well as the cure time. As explained above, the system 10 may include a cure station 46 that cures the coating material on a target. Accordingly, adjustment of the conveyer speed will determine the cure time for the coating material (e.g., faster conveyer speed may decrease cure time, slower conveyer speeds may increase cure time). The conveyer speed will also determine how long the target or a portion of the target is sprayed with coating material. The longer the target remains in front of the electrostatic tool 22 the more coating material will collect on the target. The conveyer speed may vary between approximately 700-800 cm/min, 725-775 cm/min, 750-770 cm/min, or 760-765 cm/min. In step 150, the method 140 enables adjustment of the number of material coatings. As explained above, the material may be sprayed in a series of coats. Accordingly, step 150 enables a user to adjust the number of coats to reach the proper tolerances (i.e., thicknesses). For example, the product may be coated with 1, 2, 3, 4, 5, 6, 7, 8, 9, 10 or more coats. Finally, in step 152, the method enables adjustment of the distances between the target and the electrostatic tool. A greater distance may reduce the transfer efficiency of material onto the target, while reducing the possibility of the material being over coated and running on the target. A smaller distance may improve the transfer efficiency of the material onto the target. However, if the distance is too small, then the material may be over coated and/or run on the target. The distance between the target and the electrostatic tool may be between approximately 5″-15″. As explained above, particle size affects electric charge and whether the particle will dry too much between exiting the electrostatic tool and contacting the target. Furthermore, adjustment of the distance between the electrostatic tool and the target ensures that the coating material does not dry before contacting the target.

In one embodiment the method 140 may produce a part using the following parameters: coating material flowrate 70-100 cubic centimeters/min (cc/min), airflow rate 350-450 standard liters per minute (sl/min), atomization pressure 13-15 psi, voltage 50-100 kV, conveyer speeds 700-800 cm/min, distance 10″, with a single coat. In another embodiment, the method 140 may produce a part using the following parameters: coating material flowrate 80-90 cubic centimeters/min (cc/min), airflow rate 360-430 standard liters per minute (sl/min), atomization pressure 13.5-14.5 psi, voltage 75-85 kV, conveyer speeds 750-775 cm/min, distance 10″, with a single coat.

FIG. 6 is a cross-sectional view of an embodiment of a target 160 coated with a coating material 162 (e.g., PTFE). As explained above, the target may be a device such as an implantable medical device, syringe needles, stents, guide wires (e.g., flexible wire that can be inserted into a confined space to act as a guide for subsequent insertion of a stiffer or bulkier instrument), catheters, etc. In the present embodiment, the target 160 is a guide wire. The guide 160 may have a gauge between 1-40. The guide wire 160 includes a single coat 162 of coating material. However, other embodiment may include additional coatings (e.g., 1, 2, 3, 4, 5, 6, 7, 8, 9, 10 or more coatings). The coating may be a very thin coating (e.g., 0.5-1.5 microns, 0.75-1.25 microns, 0.9-1.1 microns), enabling use of the guide wire in medical applications.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray system, comprising:
an electrostatic tool configured to charge and spray a PTFE;
a material delivery system configured to deliver the PTFE to the electrostatic tool;
a gas delivery system configured to deliver an airflow that atomizes the PTFE and sprays the charged PTFE on a target; and
an infrared curing system configured to cure the PTFE on the target to produce a coating.

2. The system of claim 1, wherein the PTFE is a water-based polytetrafluoroethylene or an acid-based polytetrafluoroethylene.

3. The system of claim 1, wherein the target is a guide wire or a catheter.

4. The system of claim 3, wherein the guide wire is a 25 gauge guide wire.

5. The system of claim 1, wherein the coating is approximately 1 micron thick.

6. The system of claim 1, wherein the material delivery system comprises a pressure pot or a syringe pump.

7. The system of claim 1, wherein the electrostatic tool comprises a round spray nozzle assembly.

8. The system of claim 1, wherein the electrostatic spray system comprises a conveyer.

9. A system, comprising:
an electrostatic spray system, comprising:
an electrostatic tool having a round tip spray assembly, configured to spray polytetrafluoroethylene with an electrostatic charge; and
a controller configured to adjust parameters of the electrostatic spray system to output a polytetrafluoroethylene spray with particles with a mean diameter between approximately 32-42 microns.

10. The system of claim 9, wherein the controller includes a processor and memory, and wherein the memory is configured to store instructions executable by the processor to change operating modes of the electrostatic tool.

11. The system of claim 9, wherein the controller is configured to adjust the electrostatic spray system to produce an atomization pressure in the electrostatic tool between approximately 13-15 pounds per square inch.

12. The system of claim 9, wherein the controller is configured to adjust the electrostatic spray system to produce a coating material flow rate between approximately 5-200 cubic centimeters per minute.

13. The system of claim 9, wherein the controller is configured to adjust the electrostatic spray system to charge the polytetrafluoroethylene between approximately 75-85 kV.

14. The system of claim 9, wherein the controller is configured to adjust an airflow rate between approximately 350-450 standard liters per minute.

15. The system of claim 9, wherein the controller is configured to adjust the electrostatic spray system to move a target between approximately 700 and 800 centimeters per minute through a spray region of the electrostatic tool.

16. A method for producing a part with an electrostatic spray system, comprising:
preparing a coating material;
preparing a target for receipt of the coating material;
electrostatically spraying coating material as a spray onto the target to create a coating material layer;
adjusting parameters of the electrostatic spray system to produce approximately 32-42 micron mean diameter particle size with the coating material in the spray; and
curing the coating material layer.

17. The method of claim 16, wherein adjusting parameters of the electrostatic spray systems comprises adjusting an atomization pressure of an electrostatic tool between approximately 13-15 pounds per square inch.

18. The method of claim 16, wherein adjusting parameters of the electrostatic spray systems comprises adjusting a coating material flow rate between approximately 5-200 cubic centimeters per minute.

19. The method of claim 16, wherein adjusting parameters of the electrostatic spray systems comprises adjusting an electrostatic charge between approximately 75-85 kV.

20. The method of claim 16, wherein adjusting parameters of the electrostatic spray systems comprises adjusting an airflow rate between approximately 350-450 standard liters per minute through an electrostatic tool.
